(19) United States
(12) Patent Application Publication
(10) Pub. No.: US 2005/0103386 A1
(43) Pub. Date: May 19, 2005

(54) Check valve

(75) Inventor: Mark Magda, Cambridge, NY (US)

Correspondence Address: HESLIN ROTHENBERG FARLEY & MESITI PC, 5 COLUMBIA CIRCLE, ALBANY, NY, 12203, US

(73) Assignee: Danfoss Flomatic Corporation, Glens Falls, NY (US)

(21) Appl. No.: 10/715,702

(22) Filed: Nov. 18, 2003

(51) Int. Cl. F16K 15/02

(52) U.S. Cl. 137/541

(57) ABSTRACT

A check valve comprises a casing having a flange extending circumferentially around the inner periphery of the body. The flange defines a valve aperture for receiving a poppet valve. The poppet valve includes a stem including a plurality of legs each having an outer peripheral surface facing the inner surface of the flange. The outer peripheral surface of the legs having a first section in close proximity to the inner surface of the flange and a second section recessed or cut back from the first section. The second section defines a flow path to allow debris to pass through the valve between the outer peripheral surface and the inner surface of the flange during operation.

### TECHNICAL FIELD

This invention relates generally to valves, and more particularly, to a check valve with an improved design and construction.

### BACKGROUND OF THE INVENTION

Check valves are designed to permit the flow of fluid in one direction while preventing the fluid from flowing in the reverse direction. Conventional check valves utilize a single poppet valve within a body, which controls the flow of fluid therethrough.

Check valves are used for a number of applications, including the development of new wells containing heavy amounts of debris, e.g. sand suspended in water. As a new well is developed, water and debris are pumped out of the well by submerging a pump on the bottom of the well and directing the water and debris out through a valve mounted at or near the discharge of the pump.

However, conventional poppet valves are likely to become lodged in the interior seat provided by an annular flange within the valve body by debris. As a result, conventional poppet valves are stuck in an open position in the valve aperture, immobilizing the poppet within the valve. When this happens, it is almost impossible to dislodge the poppet valve without dismantling the check valve. In most instances a new fitting is utilized.

### SUMMARY OF THE INVENTION

Using a check valve in accordance with one or more principles of the present invention may alleviate the shortcomings of the prior art. The check valve of the present invention may be used in any type of hydraulic or other fluid flow lines such as, for example, water, fuel, or gas lines, wells, cisterns, pumping outfits or the like. Additionally, other uses may be made of the invention which falls within the scope of the claimed invention but which is not specifically described below.

In one aspect of the invention, there is provided a check valve comprising a body and a poppet valve moveably mounted within the body. The body is configured to permit fluid to flow therethrough. The body includes a flange extending circumferentially around the inner periphery of the body. The flange has an inner surface defining a valve aperture. The poppet valve is to be moveably mounted within the valve aperture. The poppet valve includes a plurality of guide legs extending through the valve aperture. Each of the plurality of guide legs has an outer peripheral surface facing the inner surface defining the valve aperture. A portion of the outer peripheral surface of each of the plurality of guide leg is recessed or cut back from the inner surface of the flange such that this portion is at a smaller radial distance from a longitudinal axis of the poppet valve than the rest of the outer surface of each guide leg.

A flow path for debris is formed between this recessed or cut back portion of the outer peripheral surface of each guide leg and the inner surface of the flange. This flow path provides for self cleaning of the valve by allowing debris to pass through the valve while preventing the lodging of the guide legs by debris in the valve aperture. The poppet valve moves around more with the recessed or cut back sections, which assist in shaking or cleaning out debris that, in the past, lodged between the guide legs and inner surface of the flange.

Additional advantages are provided through the provision of a check valve having a poppet valve with legs constructed in accordance with the principles of the present invention described and claimed herein by reducing the surface area in direct contact with the inner surface of the valve aperture. The check valve described and claimed herein assures smooth operation of the check valve by preventing the poppet valve from becoming lodged in the valve aperture by debris sticking the guide legs within the valve aperture defined by the flange.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a longitudinal cross sectional view through a check valve constructed in accordance with the principles of the present invention, and illustrating the valve in a closed position;

FIG. 2 depicts a fragmentary sectional view illustrating the poppet valve in the closed position in the valve seat in accordance with the principles of the present invention;

FIG. 3 depicts a longitudinal cross sectional view through a check valve constructed in accordance with the principles of the present invention and illustrating the valve in an open position;

FIG. 4 depicts a fragmentary sectional view illustrating the poppet valve in the open position in the valve seat in accordance with the principles of the present invention;

FIG. 5A depicts a partial prospective view of another embodiment of the outer peripheral surface of the guide legs of the poppet valve constructed in accordance with the principles of the present invention;

FIG. 5B depicts a partial prospective view of another embodiment of the outer peripheral surface of the guide legs of the poppet valve constructed in accordance with the principles of the present invention;

FIG. 6A depicts a partial cross sectional view of a conventional check valve illustrating the close relationship between the outer peripheries or surfaces of the guide legs of a poppet valve and the inner surface defining the valve aperture in an open position; and

FIG. 6B depicts a fragmentary sectional view illustrating the close proximity of the entire outer peripheral surfaces of the guide legs to the inner surface of the flange defining the valve aperture of a conventional poppet valve.

### BEST MODE FOR CARRYING OUT THE INVENTION

Presented herein is an improved check valve, which provides an enhanced poppet valve. The enhanced poppet valve includes legs having outer peripheral surfaces facing an inner surface of a flange forming a valve aperture. A section of the outer surface of each leg is recessed or cut back from the inner surface of the flange such that the radial distance of this section from the longitudinal axis of the poppet valve is less than the radial distance between the rest of the outer peripheral surface of the leg and the longitudinal axis. With this recessed section, a flow path is created to allow for debris to pass between the outer peripheral surface of each guide leg and the inner surface of the flange. The improved check valve assures smooth operation by preventing the poppet valve from becoming lodged within the check valve as debris, such as, for example, sand, passes through the valve while the valve is open.

Conventional check valves have a tubular valve casing and a poppet valve mating with a valve aperture formed by a flange on the inner surface of the valve casing. The poppet valve opens and closes the valve aperture depending on the pressure differential upstream and downstream of the check valve.

Conventional poppet valves utilize a valve stem having a plurality of legs extending downwardly through the valve aperture defined by the flange from a valve head to aid in guiding the poppet valve in its opening and closing movements in the valve aperture. Two examples of check valves having this configuration are described in more detail in U.S. Pat. No. 3,001,546 to Salisbury and U.S. Pat. No. 4,129,144 to Andersson et al, which are hereby incorporated herein by reference.

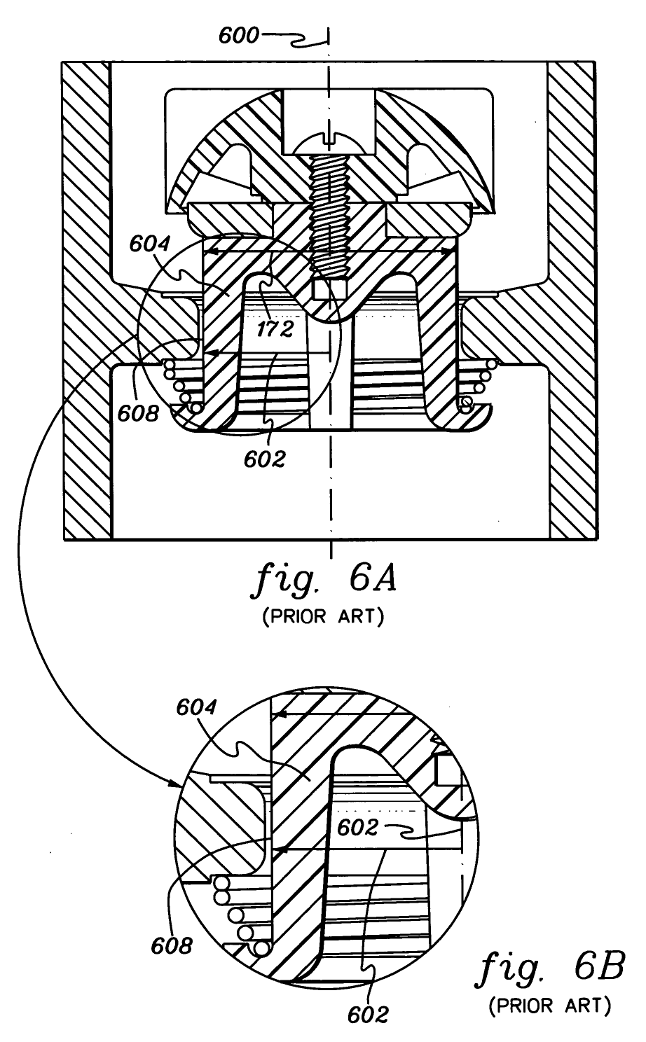

As illustrated in FIGS. 6A and 6B, the outer peripheries or surfaces 608 of the guide legs 604 of the poppet valve are formed on the arc of a circle having a diameter slightly less than the inner diameter of the valve aperture defined by the flange 104. The entire outer surface of the guide leg is at the same radial distance 602 in a longitudinal direction with respect to axis 600 of the poppet valve. However, the entire outer surface of each leg of the poppet valve is in close proximity to, and may come into contact with, the inner surface of the flange. This causes high friction during operation and provides a large surface area in close proximity with the inner surface of the flange, increasing the chance that debris will stick between the outer peripheral surfaces of the guide legs and the inner surface of the flange forming the valve aperture. As a result, average and large-sized debris tends to become lodged between the guide legs and inner surface of the valve aperture. This immobilizes the poppet valve and may stick the valve in the open position. An average-sized debris may have a grain size with a diameter greater than 0.015 inches and a large-sized debris may have a grain size with a diameter greater than 0.030 inches.

Surfaces 608 also have sharp edges which can catch on the inner surface of the valve aperture during operation, particularly if a bur exists on this inner surface. All of these conditions may effect the smooth operation of the check valve, particularly with respect to the opening and closing movement of the poppet valve in the valve aperture within the check valve casing.

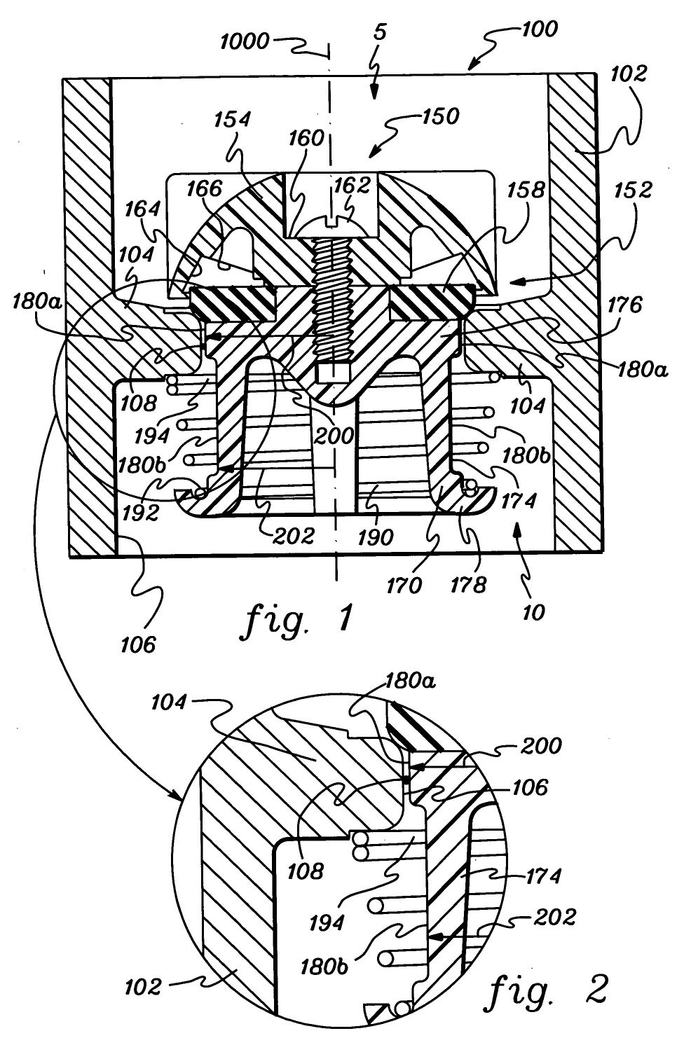

In the illustrative embodiment shown in FIGS. 1-5, a check valve 100 includes a tubular body or casing 102 containing a poppet valve 150 in accordance with the principles of the present invention. The ends (not shown) of tubular casing 102 may be internally threaded or otherwise adapted to facilitate connection of check valve 100 with adjacent portions of a hydraulic flow line. Tubular casing 102 may be slightly increased in diameter inwardly of the end portions to provide a valve chamber in the casing for supporting poppet valve 150.

Within tubular casing 102, an inwardly extending circumferential flange 104 protruding from inner surface 106 of the casing forms a valve aperture 108. Flange 104 also effectively separates the valve chamber defined by casing 102 of the valve into an upper or downstream portion 5 and a lower or upstream portion 10. Typically, inner flange 104 is circular in shape as defined by its inner surface forming valve aperture 108. However, aperture 108 is not limited to any particular geometrical shape.

A flange 104 may be formed by drilling the casing from opposite directions (e.g. from upper portion 5 towards lower portion 10 and from lower portion 10 towards upper portion 5) in order to eliminate any burs, especially on the upstream shoulder portion, that may exist in prior art valves formed by drilling from a single direction. An example of check valves having this configuration is described in more detail in U.S. Pat. No. 6,581,633 to Andersson which is hereby incorporated herein by reference.

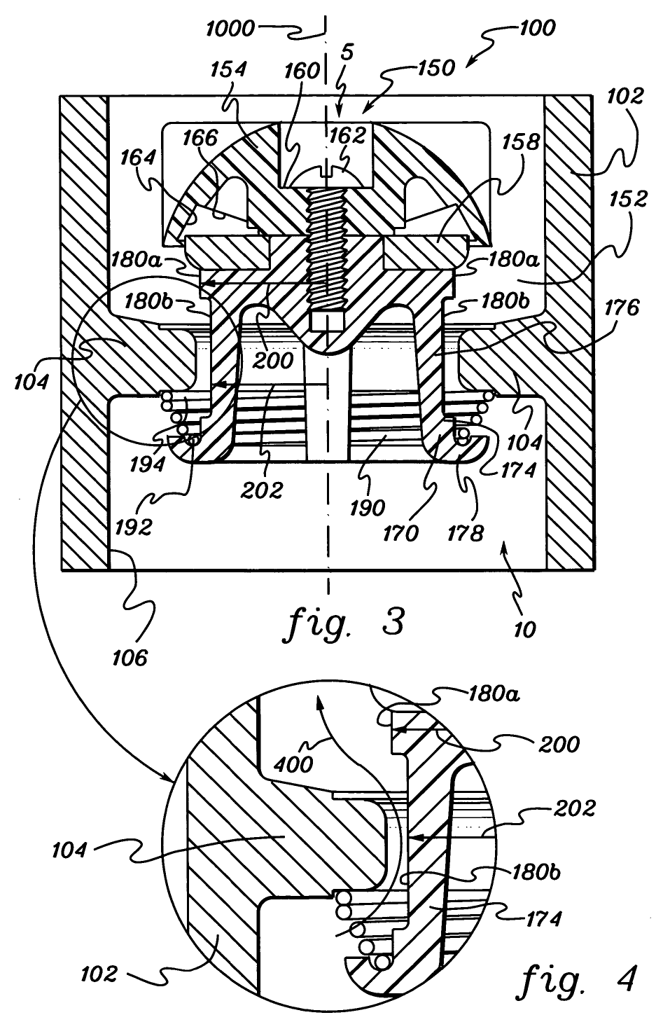

Poppet valve 150 is moveably mounted within valve aperture 108 formed by flange 104 between a closed position (as depicted FIG. 1) and an open position (as depicted in FIG. 3). Poppet valve 150 utilizes flange 104 as a valve seat and, when seated on the flange, is coaxially aligned with the longitudinal axis of valve aperture 108. Flange 104 also supports and guides poppet valve 150 during operation.

As illustrated in FIG. 1, poppet valve 150 comprises a valve body 152 including a head 154 in upper or downstream portion 5 of casing 102 and a stem 170 extending through valve aperture 108 and into lower or upstream portion 10 of the tubular casing 102. Head 154 includes a rubber disc 158 having a greater diameter than the diameter of valve aperture 108 to cover valve aperture when closed. Disc 158 cooperates with an upper shoulder portion of flange 104 to seal the valve closed and to aid in centering the poppet valve 150. Head 154 includes a flattened apex 160 which provides for a flat headed threaded member 162 extending through a central bore in head 154 and disc 158 to thread into stem 170.

The edge of the base of head 154 is annular having a diameter greater than the diameter of the valve seat. Head 154 is provided with an annular groove facing upstream and including a pair of sidewalls 164, 166. The bottom tapers (as shown in FIG. 1) at an angle with respect to the axis of the head so as to provide a tapering groove together with sidewall 164. The tapering groove is adapted to evenly receive the distorted circumference of disc 158 to prevent it from becoming jammed in valve aperture 108 when the valve is closed. Head 154 contacts the flange just inside of the outer periphery of the valve seat, thus mechanically and positively stopping the progress of poppet valve 150. Flat face 160 of head 154 supporting threaded member 162 receives the blunt of the retro pressure stabilizing entire poppet valve 150 and eliminating flutter and gyration of the poppet valve 150 during operation.

The outermost portion of stem 170 of poppet valve 150 has an outer diameter 172 that is slightly smaller than valve aperture 108. In the embodiment shown, stem 170 includes a plurality of circumferentially spaced, longitudinal legs or wings 174 extending between a base 176 and a continuous annular ring 178 which has a recess facing upstream for the purpose of providing a reaction point for the circular end of a compression spring 190.

Each of legs 174 includes an outer peripheral surface 180 facing the inner surface of the valve aperture formed by flange 104. Outer peripheral surface 180 includes a first section 180A and a second section 180B that are spaced at different radial distances from longitudinal axis 1000 of the poppet valve. First section 180A of outer peripheral surface 180 may be formed on the arc of a circle having a diameter slightly less than the inner diameter of valve aperture 108 to aid in guiding the reciprocating movement of poppet valve 150 within casing 102. First sections 180A of outer peripheral surfaces 180 of legs 174 cooperate with valve aperture 108 to maintain head 154 substantially in alignment with the valve seat.

As shown in FIGS. 2 and 4, second section 180B is recessed or cut back from first section 180A of outer peripheral surface 180 such that radial distance 202 from axis 1000 to second section 180B is less than radial distance 200 from axis 1000 to first section 180A. Second section 180B may also be spaced at a greater longitudinal distance upstream from head 154 than first section 180A. As a result, a flow path 400 (See FIG. 4) is formed between the second section 180B and the inner surface of the valve aperture formed by the flange 104 when the poppet valve is in an open position. Flow path 400 allows debris to pass through the valve between the outer peripheral surfaces of the guide legs and the inner surface of the flange forming the valve aperture while the poppet is in an open position without sticking or jamming of the poppet valve. As a result, a poppet valve constructed in accordance with the principles of the present invention is self cleaning because the poppet valve is permitted to move around within the valve aperture and shake or clean out any debris that, in the past, accumulated between the guide legs and inner surface of the flange.

In one embodiment, the edges of first section 180A and/or second section 180B are rounded off to permit legs 174 to, among other thing, easily hop over or otherwise avoid becoming lodged on any burs that may exist on the inner surface of valve aperture 108, avoid digging into or damaging the inner surface of the flange, and to reduce friction during operation.

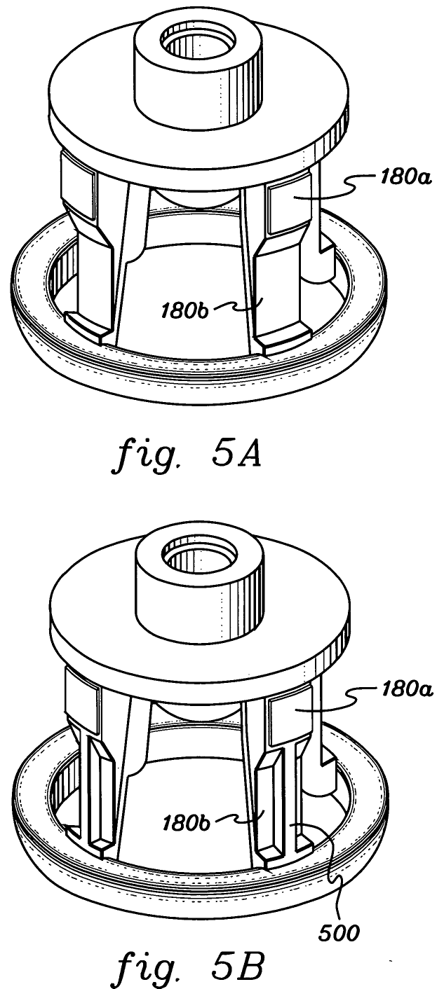

FIG. 5B illustrates a second embodiment of the poppet valve in accordance with the principles of the present invention. In this embodiment, the second portion 180B of the outer peripheral surface 180 is formed by cutting away the edges of legs 174, thereby leaving a center longitudinal portion 500 of outer peripheral surface 180 at the same radial distance from axis 1000 as first portion 180A. In this embodiment, center portion 500 aids in guiding the reciprocating movement of poppet valve within casing by cooperating with the valve aperture to maintain head 154 substantially in alignment with the valve seat.

Poppet valve 150, and particularly head 154, is maintained in position by an elastomeric spring means 190 such as, for example, a stainless steel coil spring. Spring 190 is telescoped over guide legs 174. A first end 192 of spring 190 is supported or, alternatively, anchored against retaining ring 178 formed at the ends of legs 174. Opposite end 194 of spring 190 is supported or, alternatively, anchored against the outer periphery of stem 170 or the lower shoulder portion of flange 102 to constantly react on retaining ring 178 and bias valve head 154 to a closed position. In one embodiment, an anti-spin lug may be used to anchor opposite end 194 on the lower shoulder portion of flange 102.

The valve operates in the usual manner of a check valve to provide an opening in the valve when the pressure in upstream portion 10 of valve casing 102 is sufficient to overcome the force imposed on valve head 154 by spring means 190 and to be closed by action of spring means 190 when the pressure upstream of the valve is decreased. When the valve opens and fluid is passing through valve aperture 108 and the openings between legs 174 and between second portion 180B and the inner surface of the flange, disc 158 is completely removed from flange 102. As valve head 154 is moved back and forth in it's opening and closing movements, guide legs 174 cooperate with the valve aperture defined by flange 102 to maintain valve head 154 substantially in alignment of the valve seat.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A check valve comprising:
a body configured to permit fluid to flow therethrough, said body including a flange extending circumferentially around an inner periphery of the body, the flange having an inner surface defining a valve aperture; and
a poppet valve moveably mounted within the valve aperture, said poppet valve including a longitudinal axis, a head and a plurality of guide legs extending from the head and through the valve aperture, each of the plurality of guide legs including an outer peripheral surface facing the inner surface of the flange, the outer peripheral surface including a first section and a second section, wherein the second section is recessed back from the first section in relation to the inner surface of the flange.

2. The check valve of claim 1, wherein the second section of the outer peripheral surface is spaced at a greater distance along the longitudinal axis away from the head than the first section of the outer peripheral surface.

3. The check valve of claim 1, wherein outer edges of the first and second sections of the outer peripheral surfaces are rounded.

4. The check valve of claim 1, wherein the second section of the outer peripheral surface forms a flow path with the inner surface of the flange to permit debris to pass between the second section and the inner surface of the flange while the valve is in an open position.

5. The check valve of claim 1, wherein the outer peripheral surface includes a third section extending longitudinal along a center portion of the outer peripheral surface of the guide leg, wherein the third section is at a same radial distance from the longitudinal axis as the first section.

6. The check valve of claim 1, wherein the first section is in close proximity to the inner surface of the flange to aid in guiding the poppet valve in the valve aperture during operation.

7. The check valve of claim 1, wherein the first section includes a diameter formed on an arc of a circle having a diameter slightly less than a diameter of the valve aperture.

8. A check valve comprising:
a body configured to permit fluid to flow therethrough, said body including a flange extending circumferentially around the inner periphery of the body, the flange having an inner surface defining a valve aperture; and
a poppet valve moveably mounted within the valve aperture, said poppet valve including a longitudinal axis, a head and a plurality of guide legs extending from the head through the valve aperture, each of the plurality of guide legs including an outer peripheral surface facing the inner surface of the flange, the outer peripheral surface including a first section spaced at a first radial distance from the longitudinal axis and a second section spaced at a second radial distance from the longitudinal axis to allow debris to pass between the second section and the inner surface of the flange while the valve is in an open position, wherein the first radial distance is greater than the second radial distance.

9. The check valve of claim 8, wherein the second section of the outer peripheral surface is spaced at a greater distance away from the head than the first outer peripheral surface.

10. The check valve of claim 8, wherein outer edges of the first and second sections of the outer peripheral surfaces are rounded.

11. The check valve of claim 8, wherein the second section of the outer peripheral surface forms a flow path with the inner surface of the flange to allow debris to pass therebetween.

12. The check valve of claim 8, wherein the outer peripheral surfaces includes a third section extending longitudinal along a center portion of the outer peripheral surface of the guide leg, wherein the third section is at the same radial distance from the longitudinal axis as the first section.

13. The check valve of claim 9, wherein the first section is in close proximity to the inner surface of the flange to aid in guiding the poppet valve in the valve aperture during operation.

14. The check valve of claim 9, wherein the first section includes a diameter formed on an arc of a circle having a diameter slightly less than a diameter of the valve aperture.

15. A check valve comprising:
a body configured to permit fluid to flow therethrough, said body including a head and a flange extending from the head and circumferentially around the inner periphery of the body, the flange having an inner surface defining a valve aperture; and
a poppet valve moveably mounted within the valve aperture, said poppet valve including a longitudinal axis, a head and a plurality of guide legs extending through the valve aperture, each of the plurality of guide legs including an outer peripheral surface facing the inner surface of the flange, wherein a flow path is defined between a section of the outer peripheral surface and the inner surface of the flange while said poppet valve is in an open position to allow for debris to pass between the outer peripheral surfaces and the inner surface of the flange.

16. The check valve of claim 15, wherein the flow path is defined longitudinally along the guide legs at a distance from the head of the poppet valve.

17. The check valve of claim 15, wherein a second section of the outer peripheral surfaces of the guide legs is in close proximity to the inner surface of the flange to aid in guiding the poppet valve during operation.

18. The check valve of claim 16, wherein the section defining the flow path with the inner surface of the flange is at a smaller radial distance from the longitudinal axis of the poppet valve than the second section.
